(19) United States
(12) Patent Application Publication
(10) Pub. No.: US 2021/0116027 A1
(43) Pub. Date: Apr. 22, 2021

(54) SECURING UNIT FOR SETING A PREDEFINED POSITION OF A COMPONENT OF A TRANSMISSION, AND METHOD FOR OPERATING THE SECURING UNIT

(71) Applicant: ZF Friedrichshafen AG, Friedrichshafen (DE)

(72) Inventors: Sascha Rosentreter, Espelkamp (DE); Andreas Giefer, Lemförde (DE)

(73) Assignee: ZF Friedrichshafen AG, Friedrichshafen (DE)

(21) Appl. No.: 16/464,369

(22) PCT Filed: Oct. 23, 2017
(86) PCT No.: PCT/EP2017/076953

§ 371 Date: May 28, 2019

(30) Foreign Application Priority Data
Nov. 28, 2016 (DE) 10 2016 223 551.6

(51) Int. Cl. F16H 63/34; F16H 63/48

(52) U.S. Cl. CPC F16H 63/3491; F16H 61/28; F16H 63/3466; F16H 63/48

(57) ABSTRACT

A securing unit for setting a predetermined position of a component of a transmission may include the following: an actuator coupled to a force transferring unit for setting the predetermined position of the component of the transmission; a supporting unit that is movable in a direction of movement in relation to the actuator, and is connected to the actuator via a spring; a triggering unit with a toggle unit, wherein the toggle unit is interconnected between the actuator and the supporting unit; and a fixation unit including an electromagnet, wherein the fixation unit is configured to retain the toggle unit in a fixed position when the electromagnet is supplied with a current to fix the actuator in relation to the supporting unit.

### RELATED APPLICATIONS

This application is a filing under 35 U.S.C. §371 of International Patent Application PCT/EP2017/076953, filed Oct. 23, 2017, and claiming priority to German Patent Application 10 2016 223 551.6, filed Nov. 28, 2016. All applications listed in this paragraph are hereby incorporated by reference in their entireties.

### TECHNICAL FIELD

The present invention relates to a securing unit for setting a predefined position of a transmission, and a method for operating the securing unit, according to the independent claims.

### BACKGROUND

Automatic transmissions are often used in modern vehicles, which significantly simplify gear selection for the driver of the vehicle. It is, however, problematic that in certain driving situations, it must be ensured that the parking brake is actually engaged, for example, and that the driver of the vehicle fails to do so, possibly due to forgetfulness. This approach should result in a significant increase in vehicle safety, wherein no complex constructions should be necessary for achieving this increased safety level.

Based on this, the present invention creates an improved securing unit for setting a predetermined position of a transmission, and an improved method for operating the securing unit, according to the independent claims. Advantageous embodiments can be derived from the dependent claims and the following description.

The approach presented herein results in a securing unit for setting a predetermined position of a component of a transmission, wherein the securing unit has the following features:

an actuator, which is or can be coupled to a force transferring element for setting the predefined position of the component of the transmission;

a supporting unit, which is or can be moved in a direction of movement in relation to the actuator, and is connected to the actuator via a spring;

a triggering unit with a toggle unit, wherein the toggle unit is interconnected between the actuator and the supporting unit; and

a fixation unit with electromagnets, wherein the fixation unit is configured to retain the toggle unit in a fixed position when a current is supplied to the electromagnet, and to thus fix the actuator in relation to the supporting unit, and wherein the fixation unit is also configured to move the toggle unit to a released position when no current is supplied to the electromagnet, in order to allow the component of the transmission to be brought into the predefined position.

An actuator (which can also be referred to as an actuating element) can be understood to be a unit that exerts a pulling or pushing force on the force transferring element in order to bring a component of the transmission into a predefined position. The force transferring element can be a cable pull, for example. The component of the transmission can be a parking lock (or parking lock latch), or a parking lock unit of the transmission, which is intended to prevent the vehicle from rolling when it is parked. The predetermined position of the component of the transmission can be a retained position of the parking lock latch gearwheels of the transmission, thus the activated or engaged position of the parking lock or parking lock unit. A supporting unit (which can also be referred to as a supporting element), can be a moving element in the securing unit, for example, which bears against the actuator with a spring, and is configured to tension a securing mechanism in order to enable the actuator to be brought into the position in which the actuator brings the component of the transmission into the predetermined position when no current is supplied to the electromagnet. A direction of movement can be understood to be a direction corresponding to the possible movement or travel path of the supporting element in relation to the actuator within a tolerance range of, e.g., 10 percent. A triggering unit can be understood to be a device or mechanism which can be retained in two different positions in a bi-stable manner. In particular, the triggering unit can be fixed in place by the toggle unit, which secures the actuator and the supporting unit in the fixed position, i.e. such that they cannot move in relation to one another, while in the released position, the actuator can be retained such that it can move in relation to the supporting unit, and at the same time, the actuator, when in the released position, can bring the component of the transmission into the predetermined (safety) position. The fixation unit can be configured to bring the toggle unit into the fixed position or to retain it in such a position, when a current is supplied to the electromagnet. The toggle unit of the triggering unit can have at least two interconnected lever elements, of which the first is connected to the actuator and the second is connected to the actuator.

The approach presented herein is based on the knowledge that in a vehicle emergency, or when the vehicle breaks down, the electromagnets can be switched off, allowing the toggle unit to be brought into the released position, such that the predetermined position of the component of the transmission can also be safely obtained in these cases. In particular, when the electromagnet is shut off, the fixation unit or the toggle unit can be brought from the fixed position to the released position in this case by means of the spring, such that the actuator is slid into a desired position that corresponds to the predetermined position of the component of the transmission. The approach proposed herein offers the advantage of creating a securing unit with very simple technical means, that is also compact, which also reliably enables the component of the transmission to reach the predetermined position in emergencies, in order to thus ensure an additional safety function.

An embodiment of the approach presented herein in which the toggle unit has at least one lever element that is oriented in a direction in the fixed position that substantially corresponds to the direction of movement between the supporting element and the actuator. By way of example, the direction of the lever element is oriented within a tolerance range of ten percent from the direction of movement between the supporting unit and the actuator. Such an embodiment of the approach presented herein offers the advantage of a very robust and reliable coupling of the actuator to the supporting element, because the forces acting between the supporting element and the actuator are substantially exerted longitudinally along the lever element. At the same time, such an embodiment offers the advantage that it can be executed very efficiently with regard to saving space.

An embodiment of the approach presented herein in which the toggle unit bears on a stop element of the actuator when in the fixed position and/or the released position is also beneficial. Such an embodiment of the approach proposed herein offers the advantage of bringing the toggle unit quickly and reliably into the fixed position and/or the released position, without the need for complicated structural measures.

According to another embodiment of the approach proposed herein, the fixation unit can be configured to allow a movement of the actuator in relation to the supporting unit when in the released position. As a result, the actuator can be brought into the aforementioned desired position by means of the spring when in the released position, in order to thus reach the predetermined position of the component of the transmission. In particular when the electromagnet is switched off, this component of the transmission can be reliably brought into the predetermined position.

A securing unit can be produced such that it is very small and compact according to another embodiment of the approach proposed herein, when the toggle unit and/or the fixation unit encompasses the actuator in the form of a clamp or in a U-shaped form. In particular, such an embodiment offers the possibility of exerting forces on the actuator at two opposing sides by means of the toggle unit and/or the fixation unit, such that the sections of the toggle unit and/or the fixation unit that exert these forces at numerous engagement points on the actuator are smaller and nevertheless robust enough to obtain the desired functionality.

An embodiment of the approach proposed herein in which the fixation unit is configured to be moved in a direction substantially perpendicular to the direction of movement between the actuator and the supporting unit is of particular advantage. Such an embodiment of the approach proposed herein offers the advantage of a likewise very compact construction of the securing unit while avoiding overlapping of movement paths of the individual components or elements of the securing unit.

Furthermore, according to another embodiment of the approach proposed herein, the electromagnet of the fixation unit can be configured to exert a magnetic force on a receiver plate located on a connecting element, which connects two subsections of the fixation unit connecting opposing sides of the actuator. Such an embodiment of the approach proposed herein offers the advantage of efficiently using the necessary components of the fixation unit for multiple purposes. In particular, the two subsections of the fixation unit connecting opposing sides of the actuator can be connected by the receiver plate on the connecting element, and an engagement point can be created for the electromagnet.

In order to nevertheless enable a reliable transfer of a gear selection desire by the driver from the transmission selection shifter to the transmission when the securing unit is in normal operation, thus not in the emergency operation mode, the fixation unit can have at least one groove according to an embodiment of the approach proposed herein, into which a tongue on the toggle unit extends. When the electromagnet is switched on, the actuator coupled to the supporting unit can move to the fixed position as a result of the groove into which the pin on the toggle unit extends and in which the pin can slide, thus ensuring a “normal operation” of the gear selection shifter, or a change in the positions of the components of the transmission in relation to one another.

An embodiment of the approach presented herein in which a main extension of the groove in the fixation unit deviates within a tolerance range from the direction of movement between the actuator and the supporting element is particularly advantageous. By way of example, this direction of the main plane of extension of the groove in the fixation unit can deviate a maximum of ten degrees from the direction of movement between the actuator and the supporting element. In this manner, the fixation unit or the toggle unit can be brought into the released position though the effects of the spring force of the spring bearing on the supporting element, such that the actuator can be pushed into the desired position by the spring, in order to obtain the predetermined position or placement of the component of the transmission. At the same time, it can nevertheless be ensured that the pin can also slide within the groove without larger frictional losses in normal operation.

According to another embodiment of the approach proposed herein, there can be a stop element opposite the supporting element in relation to the actuator, against which the actuator is braced when the component of the transmission is in a predetermined position. Such an embodiment of the approach proposed herein offers the advantage of being able to bring the actuator to a defined position when the predetermined position of the component of the transmission has been or will be reached. At the same time, such a stop element offers the advantage of providing a defined abutment, which can then be used to tension the securing unit when the supporting element moves toward the actuator to tension the spring.

An embodiment of the approach presented herein in which there is a drive unit configured o move the supporting element in the direction of movement is particularly advantageous, in particular wherein the drive unit is configured to move the supporting element linearly. Such a drive unit can be an electric motor, for example, which is optionally connected to a small gearing, in order to actively move the supporting element. As a result, a tensioning of the spring can be very easily implemented in a small assembly for the functionality of the approach proposed herein.

To ensure that a vehicle can also be rolled away in an emergency operation, according to another embodiment of the approach proposed herein, an emergency release unit can be provided that is configured to move an axle passing through the actuator and the supporting element in the direction of movement, wherein the axle is secured to the force transferring element, in particular wherein the emergency release unit includes a cable pull unit and/or a lever unit located on a side opposite the supporting element in relation to the actuator. The force transferring unit, e.g. a cable, is secured to this axle, which is likewise secured at another point to the transmission or the component of the transmission. It can also be ensured with the emergency release unit that the vehicle can move when the toggle unit, or the fixation unit, are in both the fixed position as well as in the released position. By way of example, the emergency release unit can be operated or activated by means of an activation cable pull unit for this, which can be manually actuated by a roadside emergency or repair service technician.

### BRIEF SUMMARY

A method for operating a securing unit according to any of the variations presented herein is also advantageous, wherein the method comprises the following steps:

moving the supporting element and the actuator toward one another to tension the spring; and

bringing or retaining the fixation unit in the fixed position by supplying a current to the electromagnet.

The aforementioned advantages can also be efficiently obtained by such an embodiment of the approach proposed herein.

An embodiment of the approach presented herein is also conceivable, in which a control device is configured to execute and/or initiate the steps of any variation of the method specified herein in corresponding units. Such an embodiment of the approach presented herein in the form of a control device also offers an efficient and technically simple possibility for implementing the aforementioned advantages.

A control device can be an electrical device that processes electrical signals, e.g. sensor signals, and outputs control signals on the basis thereof.

The control device can have one or more suitable interfaces, which can be in the form of hardware and/or software. In the form of hardware, the interfaces can be part of an integrated circuit, for example, which implements functions of the device. The interfaces can also be individual integrated circuits, or at least partially comprised of discrete components. In the form of software, the interfaces can be software modules on a microcontroller, for example, in addition to other software modules.

A computer program containing programming code that can be stored on a machine readable medium, e.g. a semiconductor memory, a hard drive memory, or an optical memory, and used to execute or initiate the steps of the method according to any of the embodiments described above when the program is executed on a computer or control device is also advantageous.

### BRIEF DESCRIPTION OF THE DRAWINGS

Advantageous exemplary embodiments of the approach presented herein shall be explained in greater detail below based on the attached figures. Therein:

FIG. 1 shows a schematic illustration of a vehicle with a securing unit according to an exemplary embodiment of the approach presented herein;

FIG. 2 shows a perspective view of an exemplary embodiment of the securing unit;

FIG. 3 shows the securing unit according to an exemplary embodiment of the approach presented herein, in a perspective view;

FIG. 4 shows another perspective view of the securing unit;

FIG. 5 shows another perspective view of the securing unit;

FIG. 6 shows a perspective view of an exemplary embodiment of the securing unit;

FIG. 7 shows a perspective illustration of an exemplary embodiment of the securing unit;

FIG. 8 shows a perspective illustration of a securing unit;

FIG. 9 shows a top view of an exemplary embodiment of the approach presented herein for a securing unit;

FIG. 10 shows a top view of an exemplary embodiment of the approach presented herein for a securing unit;

FIG. 11 shows a cross section view through a securing unit according to an exemplary embodiment of the approach proposed herein in an untensioned state;

FIG. 12 shows a cross section view through a securing unit according to an exemplary embodiment of the approach proposed herein in the tensioned state;

FIG. 13 shows a block diagram of a control device for initiating a method for operating a securing unit according to a variation presented herein; and

FIG. 14 shows a flow chart for a method for operating a securing unit.

### DETAILED DESCRIPTION

In the following description of preferred exemplary embodiments of the present invention, the same or similar reference symbols are used for the elements in the figures that have similar functions, wherein the descriptions thereof shall not be repeated.

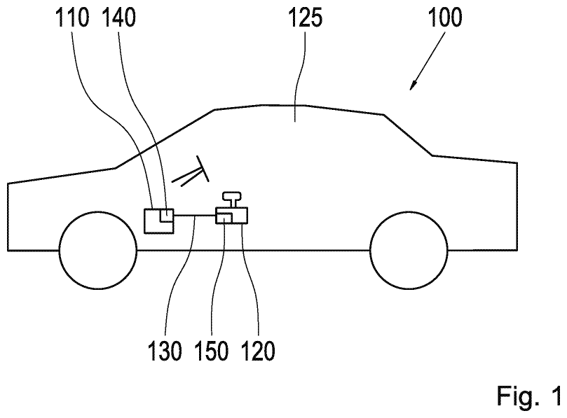

FIG. 1 shows a schematic illustration of a vehicle 100 in which a transmission 110 is located, which can be actuated by a transmission selection shifter 120 in the passenger compartment 125. By way of example, a position of the transmission selection shifter 120 can be transferred to the transmission 110 via a cable pull functioning as a force transferring element 130, wherein individual components 140 of the transmission 110, e.g. a parking lock or a parking lock unit, can be brought into a specific position, thus ensuring a specific functionality of the transmission 110. By way of example, the transmission 110 can be blocked when the activated component 140 is a parking lock, such that the vehicle is secured against rolling away (e.g. unintentionally).

If, by way of example, a driver, not shown in FIG. 1, forgets to shift the transmission selection shifter 120 to the position “parking lock” or “park” when parking the vehicle 100, the corresponding component 140 of the transmission 100, thus the parking lock unit, is not activated, such that the vehicle 100 could roll off, if no other safety measures are taken.

The approach proposed herein starts here, in that a securing unit 150 is presented, by means of which a specific component 140 of the transmission 110 is brought into a predetermined position, and the reliable engagement or activation of the parking lock unit is enabled, even if the driver of the vehicle 100 may have forgotten to do this when leaving the vehicle. The securing unit 150 can be incorporated in the transmission selection shifter 120 itself (as is shown in FIG. 1), for example, or it can be installed somewhere else in the vehicle 100, such that it can bring the component 140 of the transmission 110 into this predetermined position by means of the force transferring element 130, e.g. the cable pull, between the transmission selection shifter 120 and the transmission 110. A force transferring element 130 that exclusively connects the securing unit 150 to the relevant component 140 of the transmission 110 is also conceivable, such that further shifting functions, e.g. selection of a forward gear or reverse gear, are not transferred via this force transferring element 130. Such an exemplary embodiment, making use of an exclusive force transferring element between the securing unit 150 and the component 140 of the transmission 110, would result in increased costs as an additional element of the transmission system, but the functioning of the securing unit is ensured with greater reliability.

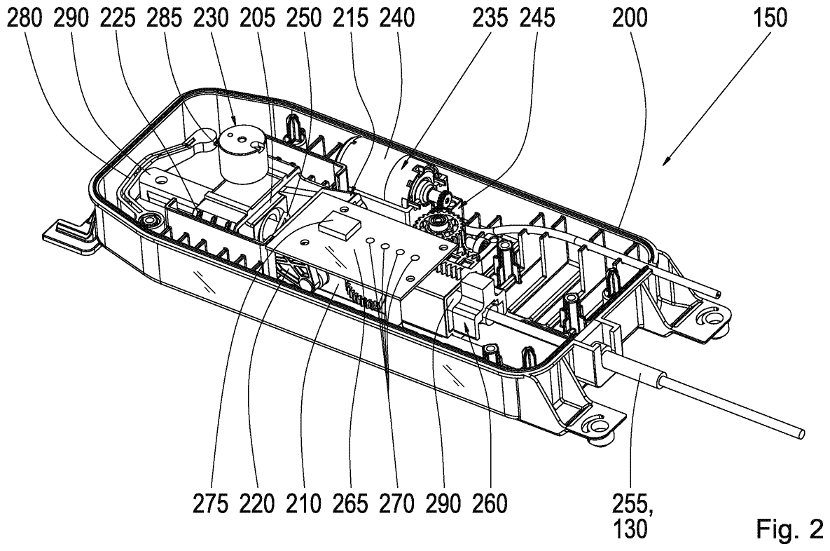

FIG. 2 shows a perspective view of an exemplary embodiment of the securing unit 150 according to the approach presented herein. The securing unit 150 is located in a housing 200, the cover of which is not shown in FIG. 2, and the walls of which are transparent in FIG. 2 for a better overview. The securing unit 150 comprises an actuator 205, a supporting unit 210, a triggering unit 215 with a toggle unit 220, and a fixation unit 225 with an electromagnet. The securing unit 150 also comprises a drive unit 235 with an electric motor 240, which powers a gearing 245, which in turn can move the supporting unit 210 (e.g. by means of a toothed rack, not discernable in FIG. 2). Furthermore, the actuator 205 is braced against the supporting unit 210 by means of a spring 250, wherein the actuator 205 is also connected to the (not shown in FIG. 2) component 140 of the transmission 110 with a cable pull 255 serving as a force transferring element 130, in order to ensure a desired functionality of this transmission 110. The cable pull 255 is received in a cable pull receiver 260, described in greater detail below. A printed circuit board 265 is also shown as part of the securing unit 150 in FIG. 2, wherein this printed circuit board 265 is populated with sensors 270, for example, located on the back surface of the printed circuit board 265 shown in FIG. 2, which are configured to detect a position of the supporting element 120 in relation to the printed circuit board 265. There is also a control device 275, which is likewise located on the printed circuit board 265, and which contains corresponding units, as shall be explained in greater detail below, for executing a method for setting a predetermined position of a component 140 of the transmission 110, or for operating the securing unit 150, which shall likewise be explained in greater detail below. Lastly, the securing unit 150 comprises an emergency release mechanism 280, which can be activated with an activating cable pull 285, for example, and pushes against an axle 290 that passes through the actuator 205 and the supporting element 210, in order to be able to mechanically or manually move the cable pull 255 or the force transferring element 230, and thus the component 140 of the transmission 110, in an emergency.

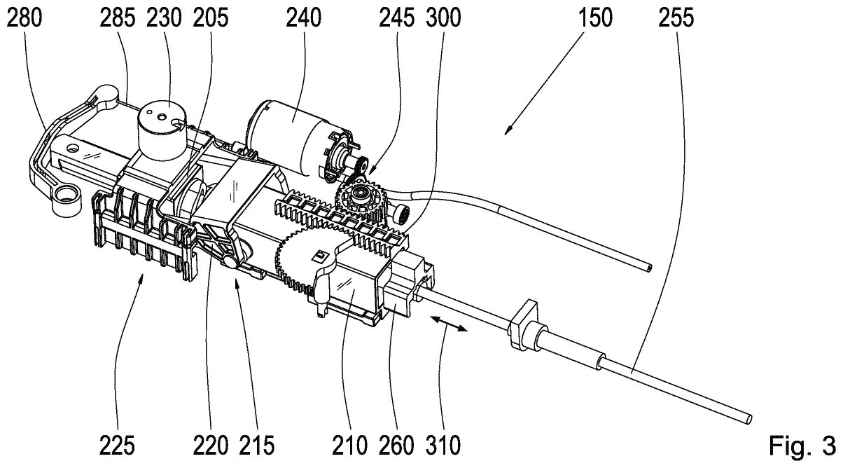

FIG. 3 shows the securing unit 150 according to an exemplary embodiment of the present invention, in a perspective view, but without the housing 200 or the printed circuit board 265 in FIG. 2. In addition to the elements explained in reference to FIG. 2, the toothed rack 300 that meshes with the gearing 245 and enables a linear movement of the supporting element 210 in the direction of movement 310 can be seen therein. Moreover, the toggle unit 220 can be seen better in FIG. 3, the functioning of which shall be explained in greater detail below.

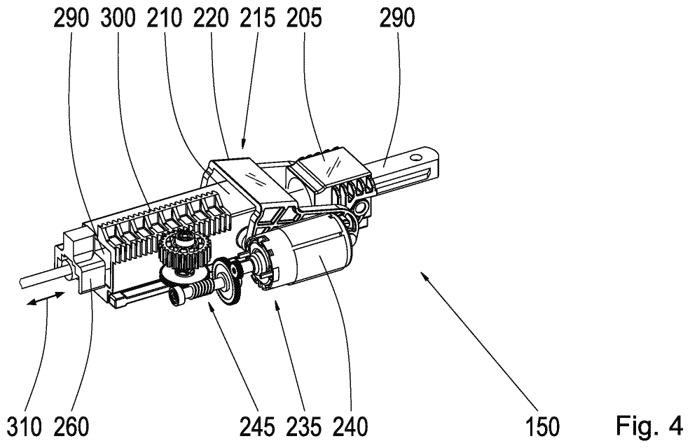

FIG. 4 shows another perspective view of the securing unit 150, but this time from a view with drive unit 235 in the foreground. Furthermore, for a better overview, the fixation unit 225 is not shown. It can be seen therein that when the electric motor 240 is running, a rotation thereof is converted to a linear movement of the toothed rack 300, which is rigidly connected to the supporting element 210 via the gearing 245, such that the supporting element 210 can be moved in the direction of movement 310, depending on which direction the electric motor 240 rotates.

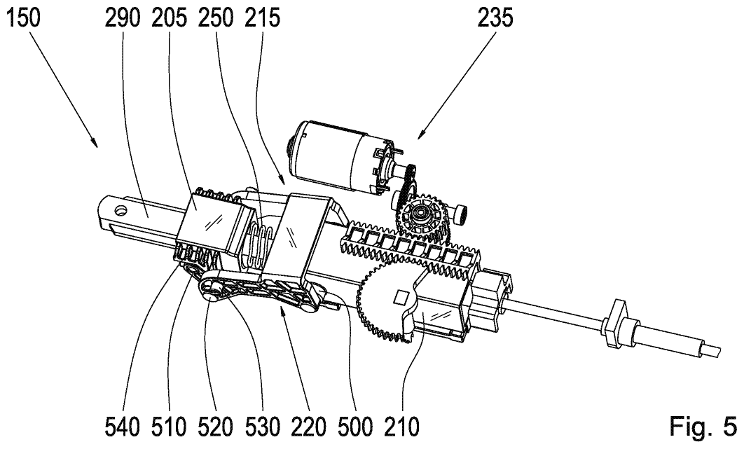

FIG. 5 shows another perspective view of the securing unit 150, from a perspective in which the drive unit 235 is in the background. The triggering unit 215 with the toggle unit 220 can be seen in FIG. 5, wherein a first lever 500 of the toggle unit 220 is in a moving connection with the supporting element 210, and a second lever 510 of the toggle unit 220 is in a moving connection with the actuator 205. The first lever 500 and the second lever 510 are in a moving connection with one another at a joint 520 of the toggle unit 220. The toggle unit 220 also has a pin 530, facing outward, i.e. away from the actuator 205. The function of this pin 530 shall be explained in greater detail below.

As can be seen from FIG. 5, the triggering unit 215, or the toggle unit 220 encompasses both the supporting unit 210 as well as the actuator 205 in the manner of a clamp. In particular, there are likewise two levers connected in an articulated manner to one another on the back of the toggle unit 220, which are concealed in FIG. 5 by the supporting unit 210, the actuator 205, the spring 250, and/or the axle 290, wherein a person skilled in the art will realize, however, that the assembly of these interconnected levers corresponds to the assembly and connection of the first lever 500 to the second lever 510, and the respective attachments to the supporting unit 210 and the actuator 205. The toggle unit 220 can thus be regarded as having two parts, wherein a first part contains the first lever 500 and second lever 510 shown in the foreground in FIG. 5, and the second part contains the other levers, partially concealed in the background, which are connected to one another and to the actuator 205 and the supporting unit 210, in a manner analogous to the first and second levers 500 and 510.

It can also be seen in FIG. 5 that the second lever 510 bears on a stop element 540 of the actuator 205, and is braced in a specific position, the released position in this case, by this stop element 540.

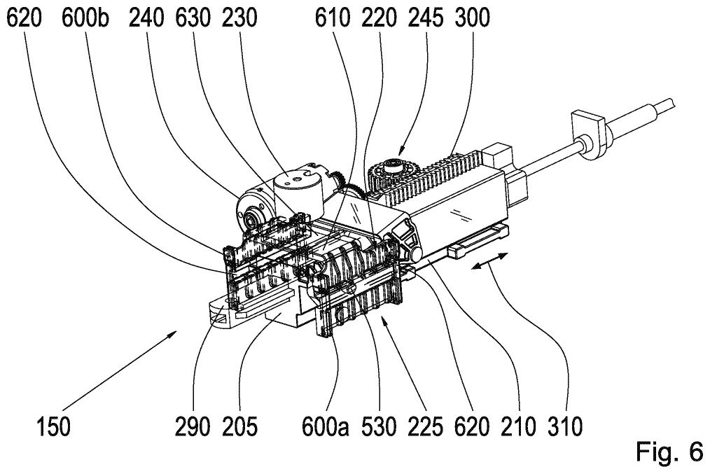

FIG. 6 shows a perspective view of an exemplary embodiment of the securing unit 150. In addition to the elements of the securing unit 150 described in the preceding passages, the fixation unit 225 is shown in greater detail in FIG. 6, wherein this fixation unit 225 is partially transparent in the illustration, in order to illustrate the functionality of the securing unit 150. In particular, it can be seen that the fixation unit has two subsections 600a and 600b on opposite sides of the actuator 205, which are connected to one another by means of a connecting element 610. In this manner, the subsections 600a and 600b of the fixation unit 225, together with the connecting element 610, form a U-shaped or clamp-like element, which encompasses the actuator 205. There is a groove 620 in each of the subsections 600a and 600b on the inside, i.e. facing the actuator 205 or the toggle unit 220, in which the pin 530 on the toggle unit 220 engages, and in which the pin 530 is also guided when the toggle unit 220 moves in relation to the fixation unit 225.

Furthermore, there is a ferromagnetic receiver plate 630 on the connecting element 610, located within the functional region of the electromagnet 230, such that when a current is supplied to the electromagnet 230, this receiver plate 630, and thus the connecting element 610, are attracted to it, such that the fixation unit 225 is moved from the released position shown in FIG. 6 to a fixed position, or is at least retained in this fixed position.

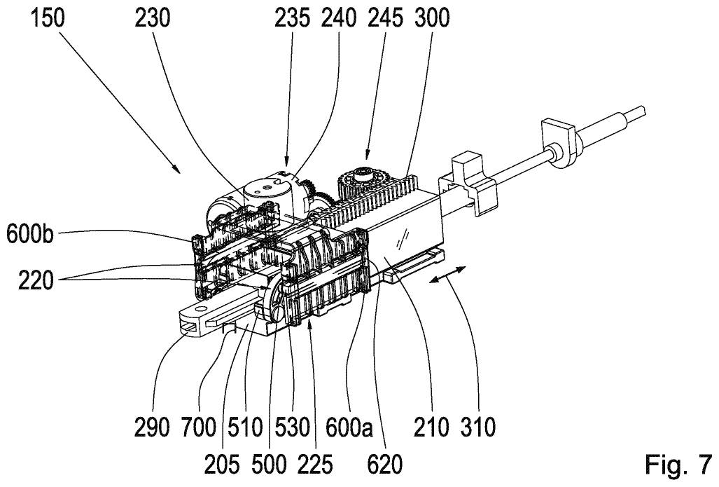

The function of the securing unit 150 shall now be explained in greater detail, wherein this shall be explained in particular on the basis of the transition from the released position of the fixation unit 225 shown in FIG. 6, to a fixed position in accordance with the illustration in FIG. 7, and back.

FIG. 7 shows a perspective illustration of an exemplary embodiment of the securing unit 150, wherein the fixation unit 225 is brought into the fixed position. In order to reach this fixed position, the gearing 245 is first rotated, starting from the position of the element of the securing unit 150 shown in FIG. 6, by the electric motor 240 of the drive unit 235, by means of which the supporting unit 210 is moved in the direction of movement 310 by the toothed rack 300, in particular toward the actuator 205. As a result, the spring between the actuator 205 and the supporting element 210, not shown in FIG. 7, is tensioned, because the actuator 205 is pressed against a stop element 700 that is part of the housing 200, not shown in FIG. 7, for example. This stop element 700 thus prevents the actuator 205 from disrupting a movement of the supporting element 210 toward the actuator 205, such that the spring would otherwise not be able to become tensioned. At the same time, the toggle unit 220 is toggled, such that the second lever 510 of the toggle unit 220 no longer points upward, but instead is substantially oriented in the direction of movement 310, in which the actuator 205 and the supporting element 210 can move in relation to one another. The first lever 500 is also brought into a raised position by the toggling of the toggle unit 220, such that the first lever 500 is also substantially oriented in the direction of movement 310. As a result, the pin 530, which is attached to the first lever 500 of the toggle unit 220, is likewise raised, and also lifts the two subsections 600a and 600b into the fixed position of the fixation unit 225 through the engagement in the groove 620. If the electromagnet 230 is then activated, i.e. supplied with a current, an electromagnetic force acts on the receiver plate 630, which secures or locks down this fixed position of the fixation unit 225, or the toggle unit 220, respectively.

If the fixation unit 225 is then secured or locked down in the fixed position according to the illustration in FIG. 7, then the toothed rack 300, the supporting unit 210, and the actuator 205 secured to the supporting unit 210 can be moved in the direction of movement 310 by the drive unit 235 with the electric motor and the gearing 245. This can require, for example, that a driver changes gears with the gear selection shifter 120, such that this change in the gear selection is detected by an electronic sensor, and the electric motor 240 is activated accordingly, to transfer the change in the gear selection to the transmission 110 by the force transferring element 130, or the cable pull 255, no longer shown in FIG. 7.

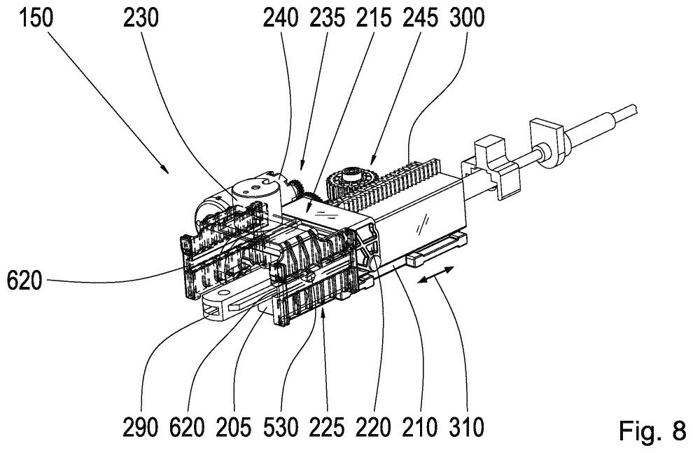

FIG. 8 shows a perspective illustration of a securing unit 150 according to an exemplary embodiment of the approach presented herein, wherein it can be seen therein that the supporting unit 210 coupled to the actuator 205 by the fixation unit 225, or triggering unit 215, which is secured in the fixed position, has now been slid or moved slightly to the right in the direction of movement 310 in relation to the position shown in FIG. 7. The fixation unit 225, including the electromagnet 230, remains in position in this case, in relation to the housing, not shown in FIG. 8. In this regard, a rigid coupling can be obtained between the actuator 205 and the supporting element 210 by the sliding of the pin 530 of the toggle unit 220 in the groove 620 in the fixation unit 225 into the fixed position, and it can also be ensured that the supporting unit 210, or, more importantly, the actuator 205 can move in the direction of movement 310, wherein the actuator 205 is coupled to the corresponding component 140 of the transmission 110 by the force transferring element 130, or the cable pull 255. In this fixed position, the securing unit 150 can be operated in the normal manner, for example, in which a change in the gear selection by the driver of the vehicle 100 can directly result in a displacement or movement of the force transferring element 130 by the activation of the electric motor 230, by means of which a change in the state of the transmission can then be readily obtained.

If the vehicle is then operated in a specific manner, in which a component 140 of the transmission 110 is to be in a predetermined position for safety reasons, this can be carried out very easily from a technical perspective by the securing unit 150. By way of example, the driver could park the vehicle 100 and forget to engage the parking lock, such that the vehicle 100 could possibly roll away. Such a safety function, in which the parking lock is automatically engaged by bringing the corresponding component 140 of the transmission 110 into the predetermined position can take place by means of the securing unit 150 in a simple manner, in that, for example, a current supplied to the electromagnet 230 is interrupted. As a result, the fixation unit 225 is pushed downward, e.g. by its own weight, and the first lever 500 of the toggle unit 220 is likewise pushed downward by the pin 530 running in the groove 620. Consequently, the second lever 510 of the toggle unit 220 is likewise pulled downward, such that the toggle unit 220 is toggled by the effects of the spring force, and the actuator 205 is pushed away from the supporting unit 210, such that the fixation unit 225, or the triggering unit 215 shown in FIG. 6, then resumes the released position.

Because the gearing 245 according to the exemplary embodiment presented herein is preferably self-locking, the actuator 205 is pushed as far as possible toward the left in FIGS. 7 and 6 by the spring 250, thus striking the stop element 700, for example. This stop element 700 forms the end position of the actuator 205, in which the force transferring element 130 or the cable pull 255 connected to the actuator 205 brings the component 140 (in this case, the parking lock handle) of the transmission 110 into the predetermined position. In this manner, it can easily be ensured that a component 140 of the transmission 110 can be reliably brought into a predetermined position by interrupting the current flowing through the electromagnet 230.

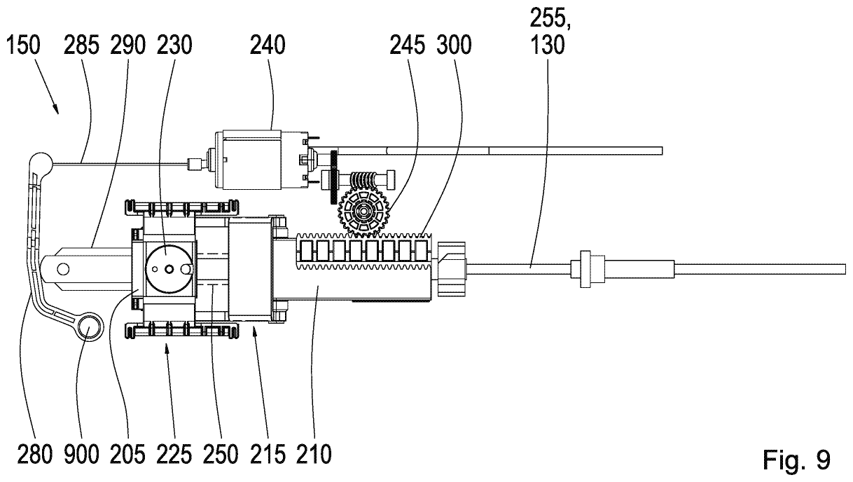

FIG. 9 shows a top view of an exemplary embodiment of the approach presented herein for a securing unit 150. FIG. 9 shows how an emergency release unit 280 in the form a lever is provided, which can be actuated by the activating cable pull 285. In this case, the lever of the emergency release unit 280 is pivoted about a pivotal point 900 by pulling on the activating cable pull 285, such that a projection 910 on the emergency release unit 280 is pressed against an end of the axle 290 lying opposite the supporting unit 210 in relation to the actuator 205. As a result, the axle 290, to which the force transferring element 130, or the cable pull 255 is attached or secured in order to bring the component 140 of the transmission 110 into the predetermined position, is pushed counter to the spring force of the spring 250, such that the component 140 of the transmission 110, e.g. the parking lock, is brought back out of the predetermined position. The parking lock can be released again in this manner, when the vehicle 100 must be moved by an emergency roadside service or a repair service. The actuation of the emergency release unit 280 can be independent of whether the fixation unit 225 or the triggering unit 215 is in the fixed position or the released position, because the force transferring element 130 is able to move in the direction of movement through the movement of the axle 290, which is not secured or locked in place by the fixation unit 225 or the triggering unit 215. In order to ensure that this emergency release unit 280 is not unintentionally triggered, for example, it can be provided that the activating cable pull 285 can only be actuated with a special tool or from a concealed location in the vehicle 100.

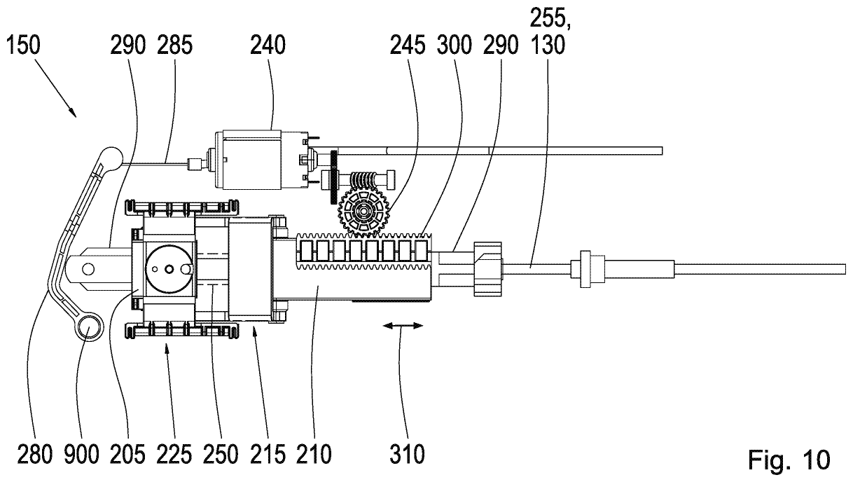

FIG. 10 shows a top view of an exemplary embodiment of the approach presented herein for a securing unit 150 in which the emergency release unit 280 is activated, such that the axle 290 is slid along the direction of movement 310, in this case toward the right, such that the position of the component 140 of the transmission 110 is altered by the force transferring element 130.

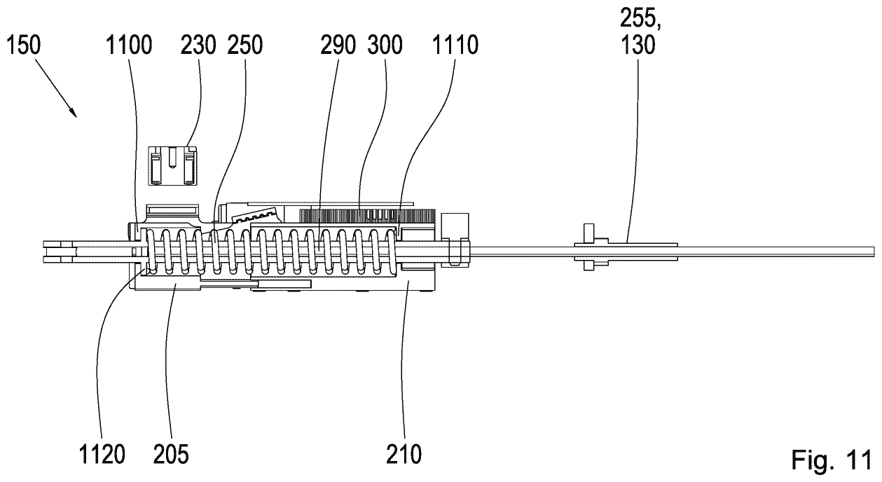

FIG. 11 shows a cross section through a securing unit 150 according to an exemplary embodiment of the approach proposed herein, in the untensioned state. It can be seen therein that both the actuator 205 and the supporting element 210 are tube-shaped, and partially slid into one another, wherein both the actuator 205 and the supporting element 210 have inner stops that support the spring 250. It is also clear that the axle 290 passes through both the actuator 205 and the supporting element 210, and is coupled or secured to the force transferring element 130, or the cable pull 255, in order to move the component 140 of the transmission 110. With respect to the inner stop 1100 in the actuator 205, it can also be seen that the spring 250 acts on a flange 1120 on the axle 290, and this flange 1120 then presses on the inner stop 1100 in the actuator 205. As a result, it can also be ensured that the axle 290 is pushed back into the starting position by the spring 250 after an actuation or resetting of the emergency release unit 280, such that a malfunctioning of or irreversible damage to the securing unit 150 can be reliably prevented by technically simple means.

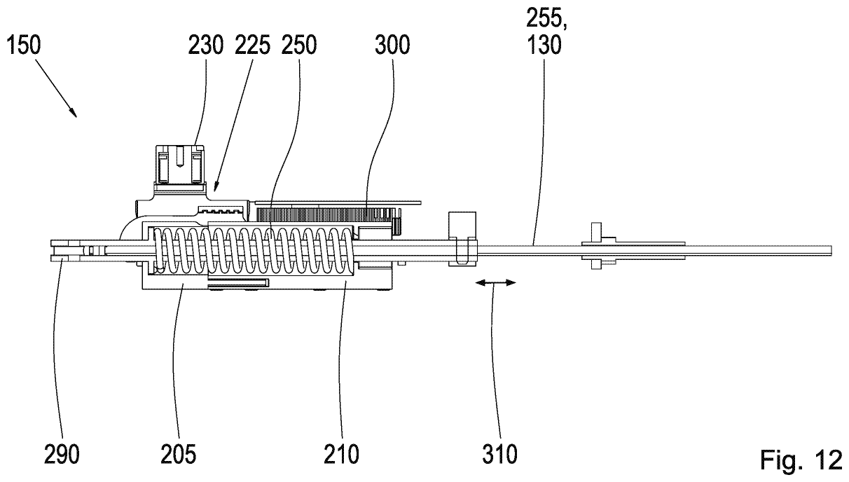

FIG. 12 shows a cross section view through a securing unit 150 according to an exemplary embodiment of the approach proposed herein in the tensioned state. It can be seen therein that the fixation unit 225 is in the fixed position, and the spring 250 is tensioned. The actuator 205 is coupled or secured to the supporting unit 210 in this state, such that when the supporting element 210 moves via the toothed rack 300, this movement along the direction of movement 310 can be transferred directly to the force transferring element 130, or the cable pull 255, by means of which the position or placement of the component 140 of the transmission 110 can be altered.

The approach presented herein thus advantageously enables a cable pull serving as a force transferring element 130 in an automatic transmission to safely engage the position “P” (park) from a position other than “P,” and thus bring a component 140 of the transmission 110 into a predetermined position through the use of sliders, in the form of the actuator 205 and the supporting unit 210, connected by toggles, which are pretensioned with a spring 250, and retained by a magnetic clamp or an electromagnet 230. Furthermore, the slider system comprising the units 205 and 210 can be slid further in a direction representing the electrical emergency function by the (toggle) levers 500 and 510, the movements of which are limited. With the manual emergency function, the cable pull receiver, and thus the cable pull attached to the transmission, can be pushed counter to the spring force of the system into the position “not P.” The entire system is configured, e.g. to make an automatic transmission 110 capable of shift-by-wire shifting with a cable pull actuation.

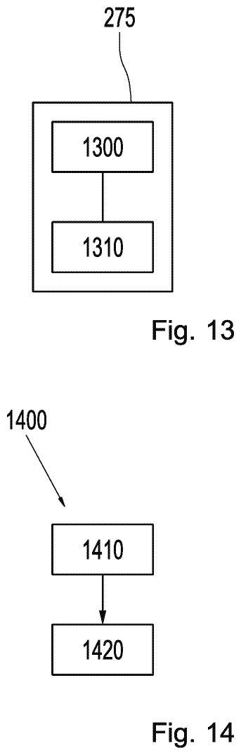

FIG. 13 shows a block diagram of a control device 275 for initiating a method for operating a securing device 150 according to any of the variations presented herein. The control device 275 comprises a unit 1300 for moving the supporting element and the actuator toward one another, and a unit 1310 for bringing or retaining the fixation unit into the fixed position by supplying a current to the electromagnet. The units 1300 and 1310 can be circuitry modules or software modules, which are configured to activate elements of the securing unit 150 accordingly, in order to carry out the specified functions.

FIG. 14 shows a flow chart for a method 1400 for operating a securing unit according to any of the variations presented herein. The method comprises a step 1410 for moving the supporting element and the actuator toward one another, and a step 1420 for bringing or retaining the fixation unit in the fixed position by supplying the electromagnet with a current.

The exemplary embodiments described herein and shown in the figures are selected merely by way of example. Different exemplary embodiments can be combined with one another, either in their entirety or with respect to individual features. An exemplary embodiment can also be supplemented by features of another exemplary embodiment.

Furthermore, steps of the method according to the invention can be repeated or executed in a sequence other than that described herein.

If an exemplary embodiment comprises an “and/or” conjunction between a first feature and a second feature, this can be read to mean that the exemplary embodiment contains both the first feature and the second feature according to one embodiment, and either just the first feature or just the second feature according to another embodiment.

### REFERENCE SYMBOLS

100 vehicle
110 transmission
120 transmission selection shifter
125 passenger compartment
130 cable pull, force transferring element
140 component of the transmission 110
150 securing unit
200 housing
205 actuator
210 supporting unit
215 triggering unit
220 toggle unit
225 fixation unit
230 electromagnet
235 drive unit
240 electric motor
245 gearing
250 spring
255 cable pull
260 cable pull receiver
265 printed circuit board
270 sensors
275 control device
280 emergency release mechanism
285 activating cable pull
290 axle
300 toothed rack
310 direction of movement
500 first lever
510 second lever
530 pin
540 stop element
600a, 600b subsections of the fixation unit
610 connecting element
620 groove
630 receiver plate
700 stop element
900 pivotal point
910 projection
1100 inner stop
1110 inner stop
1120 flange
1300 unit for moving the supporting element and the actuator toward one another
1310 unit for bringing or retaining the fixation unit in the fixed position
1400 method for operating a securing unit
1410 step for moving the supporting element and the actuator toward one another
1420 step for bringing or retaining the fixation unit in the fixed position

1. A securing unit for setting a predetermined position of a component of a transmission, wherein the securing unit comprises:
an actuator coupled to a force transferring unit for setting the predetermined position of the component of the transmission;
a supporting unit that is movable in a direction of movement in relation to the actuator, and is connected to the actuator via a spring
a triggering unit with a toggle unit, wherein the toggle unit is interconnected between the actuator and the supporting unit; and
a fixation unit including an electromagnet, wherein the fixation unit is configured to retain the toggle unit in a fixed position when the electromagnet is supplied with a current to fix the actuator in relation to the supporting unit, and wherein the fixation unit is also configured to release the toggle unit to move into a released position when the electromagnet is not supplied with a current to allow the component of the transmission to be moved into the predetermined position.

2. The securing unit according to claim 1, wherein the toggle unit has at least one lever element oriented in the fixed position in a direction that substantially corresponds to the direction of movement between the supporting unit and the actuator.

3. The securing unit according to claim 1, wherein the toggle unit bears on a stop element of the actuator when it is in the fixed position and/or the released position.

4. The securing unit according to claim 1, wherein the fixation unit is configured to allow a movement of the actuator in relation to the supporting unit when in the released position.

5. The securing unit according to claim 1, wherein the toggle unit and/or the fixation unit encompasses or encircles the actuator.

6. The securing unit according to claim 1, wherein the fixation unit is configured to move substantially perpendicular to the direction of movement between the actuator and the supporting unit in order to reach the fixed position.

7. The securing unit according to claim 1, wherein the electromagnet of the fixation unit is configured to exert a magnetic force on a receiver plate located on a connecting element that connects two subsections of the fixation unit connecting opposing sides of the actuator.

8. The securing unit according to claim 1, wherein the fixation unit has at least one groove that receives a pin of the toggle unit.

9. The securing unit according to claim 1, further comprising a stop element located opposite the supporting unit in relation the actuator, wherein the actuator is braced against the stop element when the component of the transmission is in the predetermined position.

10. The securing unit according to claim 1, further comprising a drive unit that is configured to move the supporting unit in the direction of movement.

11. The securing unit according to claim 1, further comprising an emergency release unit that is configured to move an axle passing through the actuator and the supporting unit in the direction of movement, wherein the axle is fixed in place on the force transferring element.

12. A method for operating a securing unit, the method comprising:
moving a supporting unit and an actuator toward one another; and
moving a fixation unit to a fixed position by supplying a current to an electromagnet.

13. A control device configured to execute steps of the method according to claim 12 in corresponding units.

14. A computer program configured to execute and/or initiate the method according to claim 13.

15. A machine readable storage medium on which the computer program according to claim 14 is stored.
